(19) United States
(12) Patent Application Publication
(10) Pub. No.: US 2017/0041203 A1
(43) Pub. Date: Feb. 9, 2017

(54) Provisioning and activation using a service catalog

(71) Applicant: Comptel Corporation, Helsinki (FI)

(72) Inventors: Jarkko Huuhtanen, Helsinki (FI); Harri Vormisto, Helsinki (FI)

(21) Appl. No.: 15/299,492

(22) Filed: Oct. 21, 2016

Related U.S. Application Data
(63) Continuation of application No. 12/301,606, filed on Nov. 19, 2008, now abandoned.

(30) Foreign Application Priority Data
Jun. 5, 2006 (EP) 06011588.8

(51) Int. Cl. H04L 12/24

(52) U.S. Cl. CPC H04L 41/5054; H04L 41/0806

(57) ABSTRACT

A service provisioning and activation method and system for telecommunications networks. The system operates in between a business support system (400) and a plurality of network elements (480) and comprises a service repository (450) containing service configuration data. The system comprises also an order management component (410), which includes a generic logic (412) for service provisioning and activation operations, and an operation specific functionalities module (414) comprising operation specific functionalities capable of using data from the service repository (450). The order management component (410) receives a requests from the business support system (400) and processes it according to the generic logic (412) calling the operation specific functionalities in the operation specific functionalities module (414). By means of this configuration, the system can perform a request-specific series of operations based on the received request and the data from the service repository, without the need of programming individual workflows for each different service activation, deactivation and modification situation possible in the telecommunications network.

### TECHNICAL FIELD

The present invention relates to provisioning and activation of services used in telecommunication systems.

The present invention relates also to service provisioning and activation systems in a telecommunications network. Such systems are typically connected to business support systems (BSS) and network elements of the telecommunications network, and their function is to make the telecommunications network provide the services that have been requested by the business support systems.

The present invention relates also to computer program products used to control computers in service provisioning and activation systems.

Among new communication networks rising as 3G, Next Generation Networks, all-IP, IP Multimedia Subsystem (IMS), etc. the amount of sellable products and services in operators' supply is increasing rapidly. This challenges operators' Operation and Support Systems (OSS) by significantly increased amount of network elements and services offered by network elements in operators' network to be managed. The operation and support systems (OSS) are sometimes called also as business support systems (BSS). In modern networks, activation and provisioning requests are more complex touching multiple network elements or services. Furthermore, the complex requests and multitask executions to network elements are tied with certain relations that have to be managed properly. From the competitive point of view, rapid service configuration and change management gives operators competitive edge. It is possible that in case the number of manageable service configurations grows over tens or even hundreds, the operator's current systems are not flexible enough to support large number of service configurations, or number of possible service combinations becomes un-manageable.

### BACKGROUND ART

U.S. Pat. No. 6,879,679 discloses a method to analyze telecommunications network to result in creating a provisioning plan for provisioning the network to provide services for one or more subscribers. Such a method is very useful for a service provisioning and activation system even though the publication is silent as to how the service provisioning and activation itself could be performed in an efficient way.

WO 2005/018249 discloses a system to manage telephony network. The focus of this publication is on the physical element management and network element configuration. The described solution has workflows defined on all the different service levels. Such workflows have to be predefined and they cannot be dynamically driven. This means that new provisioned products and their relations to network level services are pretty laborious to define.

### DISCLOSURE OF INVENTION

It is an object of the present invention to provide a new method and system for provisioning and activation of services used in telecommunication systems. Preferably, such a system would provide automatic, relatively fast and accurate provisioning and activation of services based on a provisioning or activation request from a business support system.

According to an aspect of the invention, there is provided a service provisioning and activation system in a telecommunications network, comprising a service repository for service configuration data and an order management component comprising a generic logic for service provisioning and activation operations. The system further comprises an operation specific functionalities module comprising operation specific functionalities capable of using data from the service repository. The service repository includes data on telecommunications products or services provided by the telecommunications network. The order management component is operative to receive a provisioning or activation request from a business support system and process the received request according to the generic logic. During such processing, the generic logic calls the operation specific functionalities in the operation specific functionalities module such that a request-specific series of operations is performed based on the received request and the data from the service repository.

According to another aspect of the invention, such a service provisioning and activation system is used to provide a business support system with a business-level view of the services in activated state for a subscription of interest in the telecommunications network.

According to a further aspect of the invention, the service provisioning and activation system is used to implement in the telecommunications network a business-level request from a business support system, the request concerning at least one change in the services provided for a subscription of interest.

According to another aspect of the invention, there is provided a method of operating the service provisioning and activation system in a telecommunications network. The method comprises receiving and interpreting a provisioning or activation request from a business support system, and responsive to the request, processing through the generic logic in the order management component based on the information in the request. The processing comprises calling operation specific functionalities in the operation specific functionalities module and making use of the service configuration data in the service repository via said called operation specific functionalities.

According to an aspect of the invention, there is also provided a computer program product comprising computer program code operable to instruct a computer system to perform the above-described method of operating the service provisioning and activation system.

The invention provides bases for embodiments that allow automatic, fast and accurate provisioning and activation of services based on a provisioning or activation request from a business support system.

There are several embodiments of the invention that accelerate and guarantee successful provisioning and activation of products and services offered by telecommunication operators and service providers.

Furthermore, the inventive concept allows several useful and advantageous embodiments, which provide numerous advantages.

An embodiment of the present invention allows creating a solution and a product that defines how decomposition from operator's sellable products can be made into technical services through a catalog, and how this data can be used in order to automate provisioning of subscriber services. In other words, this means mapping of a generic technical service or capability (from a catalog) into network element specific operations executable into physical network elements (through provisioning system).

A solution according to the invention is acting as an activator and provisioning system between operator's business domain (BSS systems; CRM, Billing, etc.) and physical network that enables communications services to subscribers (Network Elements; HLR-, IMS-, VMS-, Fixed-, Ldap-, DSLAM-, router-, etc.). Furthermore, the solutions according to embodiments of the invention can cover more OSS functionality than the traditional provisioning solutions, so instead of being just an activator, these solutions can cover several intelligent functions on high level.

Embodiments of the invention can be used to model the mapping of operator's sellable products that are managed on the BSS systems, into technical service on the network layer. The mapping is done through service specification stored in the catalog. The content of service specification may be defined by a standard, e.g. Tele Management Forum's (TMF) Shared Information Data model (SID). Even if the standards define the data model, they don't define how the data should be used in order to support provisioning and activation process. The standard defines logical way to model communication services, which is needed in order to be able to model new services and sellable products in a fast way—this is essential in highly competed, changing business environment.

Challenge is to have a complete flow of data from the Business Support System (BSS) through order management, through technical flow, service decomposition through a service catalog, into activation and down to network elements. Embodiments of the present invention make it possible to construct a solution that enables complete provisioning solution with internal capabilities to change metadata between the entities describing the capabilities of each entity.

According to an embodiment of the present invention, it's possible to use data in the generic catalog to support activation and provisioning process by interpreting the lowest atomic entities from the catalog (technical services, ResourceFacingServices, technical features, technical capabilities, etc; the technical entities supported by the network and used to build up a sellable product configuration) into one or multiple provisioning system and network element specific tasks, which can be executed into the network elements in order to enable referred generic technical service on the network layer. The provisioning system implements the logical operations for the technical services and operation can be, as mentioned, one single executable task or set of tasks, which are driven by the operation specific technical workflow.

By modelling operations for each technical feature through provisioning-system-specific and network-element-interface-specific functionalities, it's possible to gain understanding for the provisioning system as to what to do when a set of technical features are referred by the BSS system through service decomposition. From the provisioning and activation point of view, it's not sufficient only to understand what implementation-specific-functionalities match into technical services, but also to understand the relations of the technical service sets to each others from the processing point of view (some technical service has to be processed before some other one). The relations between technical services are preferably stored in the context of catalog, and their purpose is to define in what order the technical services have to be processed. On the other hand, the technical services may have a relationship to each other; one does not work without another one. For example VoIP (Voice over IP) does not work if access (e.g. Cable broadband) is not also activated with the VoIP service.

Some embodiments of the invention go even further than the mapping of technical services into executable operations and understanding the relations between atomic operations. These embodiments aim at optimised processing (time and actions point of view) by optimising the number of executables. The mapping is provided with intelligence so that it can calculate the minimum operations to be executed (delta) for subscriptions of a subscriber. For example, a subscriber might have some technical services already active on the network layer because of old products and services assigned to him, thus only the non-activated set of technical services has to be processed compared to the old ones already active.

In an embodiment of the invention, wherein in case some operation fails and it's not possible to activate a set of technical services referred by the new product assigned with a subscriber, then provisioning system can use the data from the catalog to push subscriber into state he was before starting the activation of the new product. This is also called rollback. Also mass changes into service configuration can be rolled automatically on the network layer using the data from the catalog, e.g. in case a service configuration is changed that is already assigned to number of customers (e.g. a new service is assigned with a product that has been already activated to subscribers), the data in the catalog can be used to calculate the technical services that have to be activated in order to activate the new service for all subscribers already assigned with the product. For example ‘Email’ service is assigned into a ‘Consumer broadband’ product. The system according to the embodiment can calculate the technical services, for example ‘Email basic service’, that has to be activated to all subscribers having a subscription into ‘Consumer broadband’ product.

The service repository can be kept up-to-date all the time in an embodiment, wherein the system comprises an update functionality operable to update the service configuration data in the service repository in response to a successfully performed provisioning or activation operation. Then, also the status of products of a subscription can be updated in the catalog. This allows also a further embodiment, wherein the system informs the BSS system of the successfully performed provisioning or activation operation once this has been concluded.

An embodiment including a rollback functionality can successfully handle also problem situations, for example, in case there are problems in the execution of technical services. The rollback functionality can then restore the status of the subscription valid at the moment of receipt of the provisioning or activation request.

The service repository and the order management component may be one single entity, but in a preferred embodiment the service repository and the order management component are separated. Advantages for the separated construction are that changes or updates can be easily made into the service repository without affecting the provisioning and activation logic at all. A further advantage is that there is no need to test the provisioning and activation logic, when the configuration of the service repository is changed. The generic logic will remain the same independently from the provisioned and activated products and services.

In one embodiment, the service repository and the order management component are even run in different computer systems. In a further embodiment, the computer system running the management component comprises a replicate database replicating part of the service configuration data in the service repository. This replicate database can also be called as a function library and it preferably contains the information on the product-service-technical service chains with the relationships. This configuration increases response times in the system.

As is apparent from the above disclosure, the present invention can be applied in a great variety of applications requiring automatic, fast and accurate service provisioning and activation.

### BRIEF DESCRIPTION OF DRAWINGS

For a more complete understanding of the present invention and the advantages thereof, the invention is now described with the aid of the examples and with reference to the following drawings, in which:

FIG. 1 presents a block chart of an example of data model used in service catalog according to an embodiment of the invention.

FIG. 2 presents a block chart of an example delta calculation and activation and deactivation technical services in the system according to an embodiment of the invention.

FIG. 3 presents a flowchart of a process according to an embodiment of the invention.

FIG. 4 presents a block chart of an activation system according to an embodiment of the invention.

FIG. 5 presents a block chart of an activation system according to another embodiment of the invention.

FIG. 6 presents a block chart of relationships according to another embodiment of the invention.

FIG. 7 presents a block chart of an activation system according to an embodiment of the invention.

FIG. 8 presents a block chart of an activation system according to another embodiment of the invention.

FIG. 9 presents a block chart of relationships according to another embodiment of the invention.

### LIST OF SOME TERMS USED IN THE FOLLOWING EXAMPLES

BSS, Business Support System; CRM, Customer Relation Management; OSS, Operations Support System (400).

SID, Shared Information Model.

TMF, Tele Management Forum.

Product, P (112).

Customer facing service, service, S (122).

Resource facing service, technical service, TS (132).

Service repository, also called Service catalog or Catalog (450).

Provisioning and activation system comprises activation (420) and order management (410) components, Catalog (450) and preferably Network Element Interfaces (475) and all other internal and external interfaces (405, 416, 418, 475).

Request or order (402).

Order management, also called request management or request order management (410).

Generic logic, also called generic workflow or process workflow (412).

Function library (414).

Decomposition, one function in Function library (414).

Relations, relationship, there are two different relationships mentioned. Relationships between different logical levels (114, 124) and within one logical level (140).

Rollback, automated rollback, one function in Function library (414).

Delta, one function in Function library (414).

Activation component, also called task execution (420).

Capability library, also called capability repository or network element specific data repository (430).

Capability template, also called template (434).

Capability logic (432).

Technical service (435).

Relations & dependencies between technical services (436).

Network Element Interface (475).

Network element interface module (470).

Network Element (480).

Network (481).

### BEST MODE FOR CARRYING OUT THE INVENTION

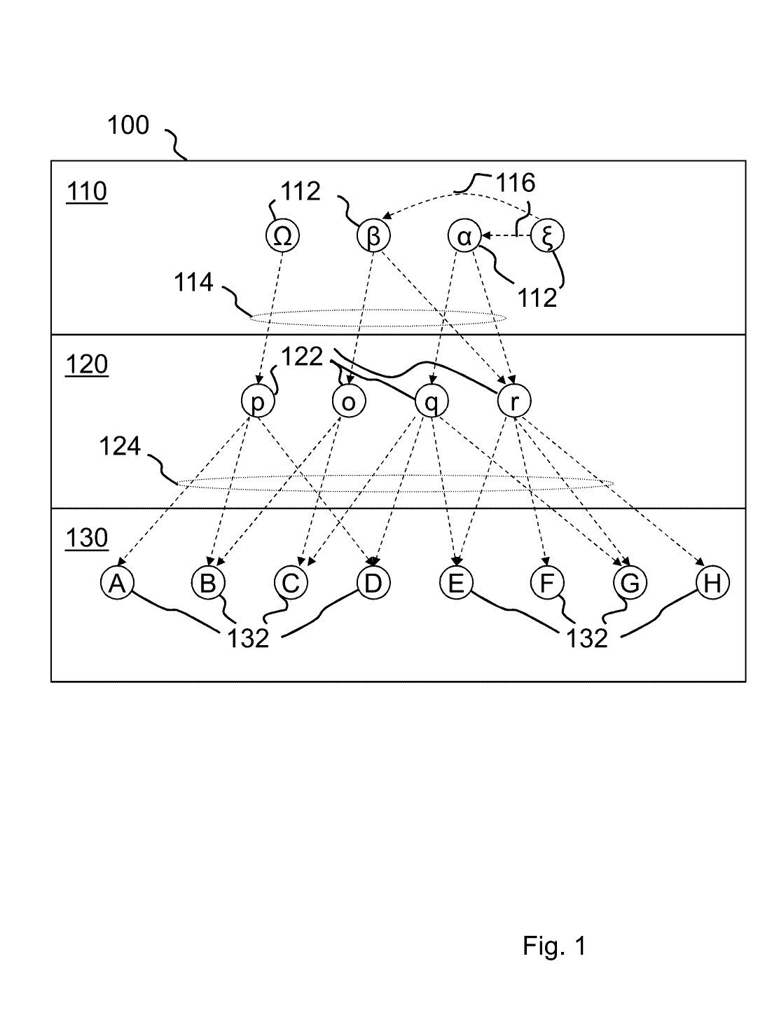

FIG. 1 presents a hierarchical model 100 in three levels of network services. The Tele Management Forum (TMF) standardisation in the Shared Information model (SID) has defined a specification for product, customer facing service and resource facing service. The SID model, or any service specification with two or more logical abstraction layers, can be utilized in the embodiments of the invention. The Service Catalog is a central OSS repository to hold product specification into network level technical services. When a product or service specification is configured into the catalog, the relationships are defined between logical levels in the catalog (e.g Product to Service 114, Service to Technical Service 124 and vice versa). The logical level for products 110 contains all the specifications regarding to products 112. The logical level for services 120 contains all the specifications regarding to services 122. The logical level for technical services 130 contains all the specifications regarding to technical services 132.

The Ω, β, α and ξ are products 112, that need services 122 p, o, q and r. The services 122 need technical services 132 A, B, C, D, E, F, G and H. The product ξ has relations 116 to other products to highlight the flexibility that is required from the catalog. For example, the entities or levels in the catalog can be defined as follows:

Product 112=a product or product bundle that is bought and assigned to a subscriber. For example “Talk a lot”-product. The catalog is the main repository for product information, which contains the price of the “Talk a lot”-product, fixed fees (e.g. monthly fee) and call tariffs. The product information can also be integrated with external system holding the master of product information (e.g. in CRM system).

Service 122=a service that is assigned with the product (“Talk a lot”) and is understandable by the subscriber. A service item is a building block for products. Service items are for example “GSM Voice”, “GSM Data”, “GSM GPRS”, “Short Message Service”, “Multimedia Service”, “DSL” and “Email”-service.

Technical service132=a technical service or capability that is most atomic building block for services without going into details of the specific network. The technical services are defined as generic network element independent services supported by the network (operator's network elements). For example “HLR T11 voice service”, “HLR T11 supplementary service for short message” or “LDAP Email service”. Each technical service 132 is an independent entity and technical services may have only relations to each others (e.g. needs, not with) but not any workflow type of processing presentation, which would be impossible to dynamically interpret during the execution.

Subscription 150=an instance information about the subscriber unique identifier and all the products 112 or services 122 assigned to him. This is not information about subscriber (which is located in the CRM system, e.g. address of the subscriber), but information about subscriber's subscriptions into entities configured into the catalog.

The challenge to be able to manage service in a catalog is that network elements do not fulfil any standardised way to model technical network level services nor common way to set the service on. On the contrary in the real life, each network element vendor has their own way to set up a service for subscriber in element and the commands to be invoked or the messages to be sent into network element vary accordingly. Traditionally telecom network elements support MML based commands, which means that provisioning and activation system has to login into network element for example over terminal connection and then invoke the commands into element, and then analyse the response. More productised network elements interfaces are also very common supporting for example remote method invocation over Java RMI, Corba IIOP object creation into network element or XML message over HTTP protocol into element. But even if multiple network elements in the telecom operators environment support MML based interface, the syntax is typically different for each element. In the same way, if some other protocol is supported, the syntax and data content is network element specific.

The logical technical services that are understandable by a human administrator are not necessarily separated on the interface command or message level, which makes it impossible to manage logical telecom service on the network element interface layer.

There is a need for an abstraction from the network element type and vendor specific provisioning and activation commands and messages into common message format. Thus, there is also a need for means to abstract common message format into manageable technical services, which can be presented in same format and managed through the same operations. For this, we need also means to define the relationship and dependencies between technical services in order to fulfil and activate only valid service sets on the network layer; it may be that some technical service may not be activated at the same time or some technical service needs data from some other technical service or technical services should activated in a predefined order.

According to the presented embodiment on a high level, it can be defined that:

The service catalog holds the specification of the service configuration—i.e. it defines how services are specified in generic network independent way, basically what must be touched when an operation is executed for a product.

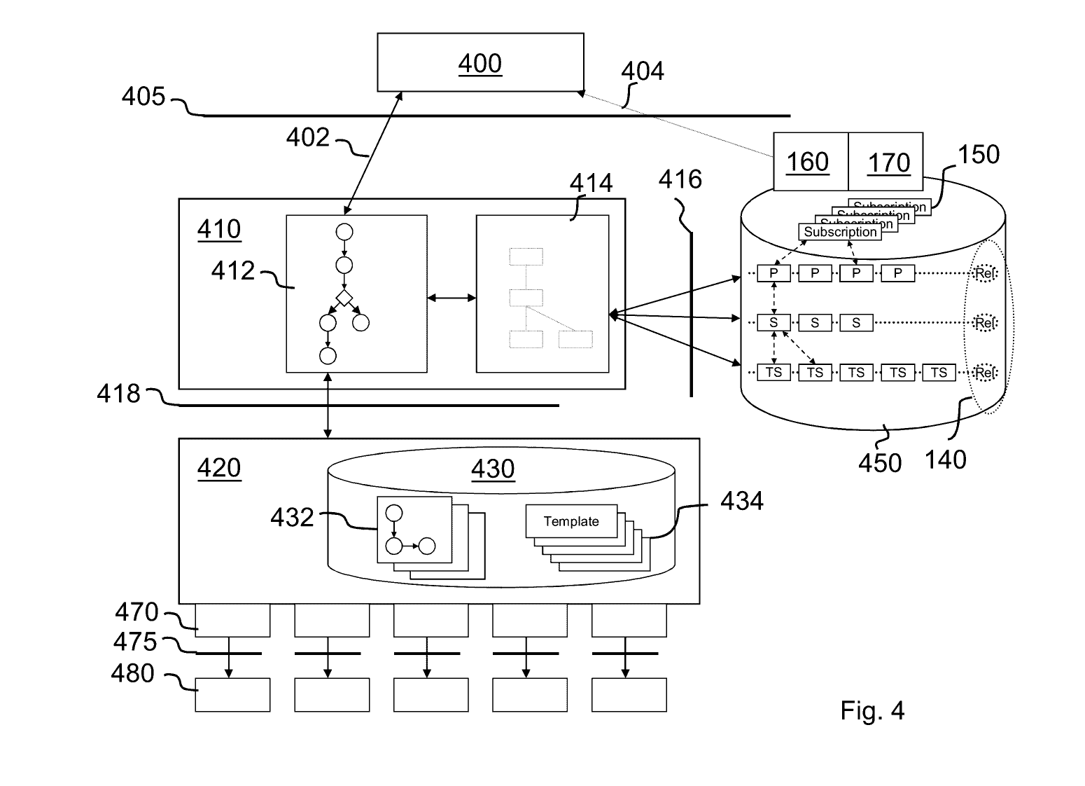

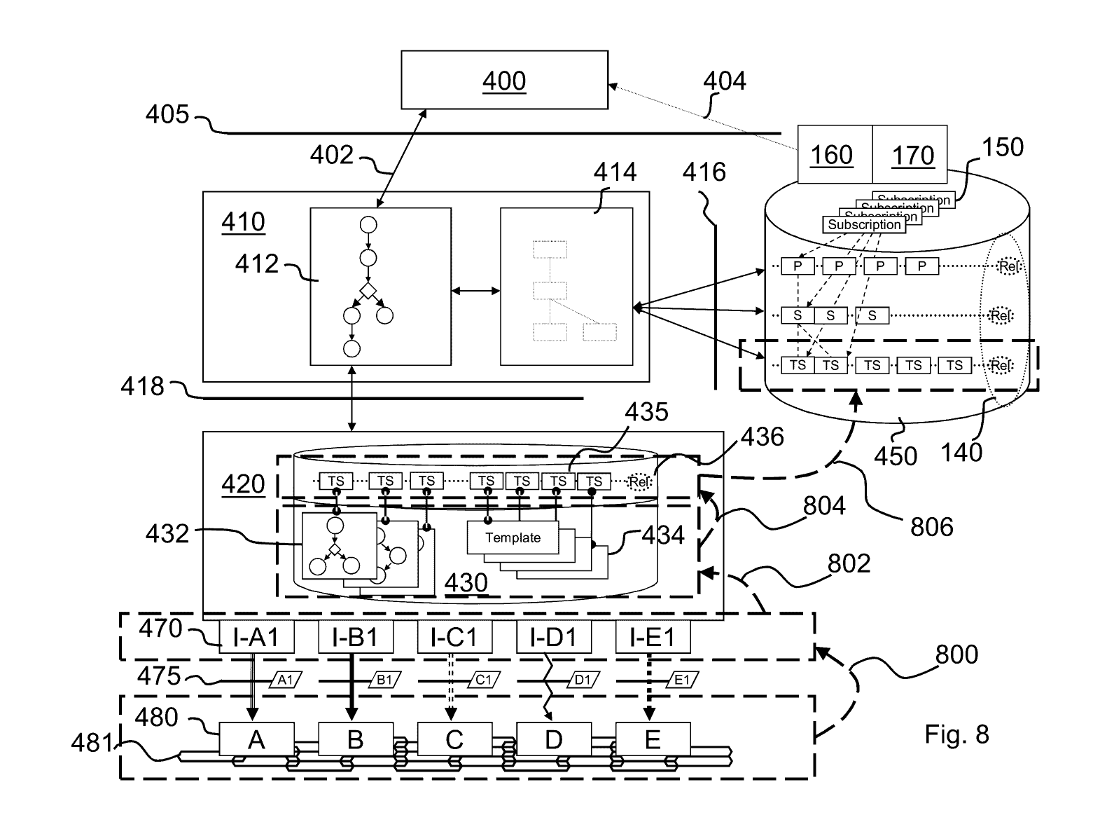

The provisioning request order manager (such as order management component 410 in the embodiments of FIGS. 4, 5, 7 and 8) holds the process definition—i.e. it defines generic process how an activation order is decomposed into technical services through a catalog and processed into network level. It can be stated that during the runtime, the generic process is dynamically driven by the service specification from the catalog. So the workflow in the activation product defines how the decomposition and execution is made.

The provisioning and activation system preferably holds all the network element specific data in a repository (can be referred as a capability repository 430, or capability templates 434 and capability logics 432 in the embodiments of FIGS. 4, 5, 7 and 8) used to convert generic technical feature into network element specific tasks or workflow. The generic and network independent dynamically received data from the catalog is converted using the data from the capability repository into network element specific operations, which can be targeted to a physical network element or elements through network elements specific interface layer.

According to another embodiment of the invention an example of activation of “Talk a lot”-product is presented.

The example is on a high level and without real parameter values in order to make the example more readily understandable.

The Customer Care sends a request into provisioning or activation system.

Request:
Operation=Activate
Product=“Talk a lot”

The request will be executed though the provisioning logic, which contains steps for

Product, Service and Technical Service management. Thus, the logic contains several levels: product level, service level and network specific data repository level.

In the product level, system will decompose the product into services IN: Operation=Activate
Product=“Talk a lot”

OUT: Operation=Activate
Services=“GSM Voice”, “GSM GPRS”, “SMS”

The information is passed to the service level, which decomposes the services into referred resources.

IN: Operation=Activate
Services=“GSM Voice”, “GSM GPRS”, “SMS”

OUT: Operation=Activate
Resources=“GSM Basic Service T11”, “GSM GPRS”, “GSM GPRS APN”,
“GSM Supplementary Services Basic”, “SMS”

On the network element specific data repository level, the generic technical services are mapped into services or capabilities, which can be a function specific workflow or network element specific tasks.

IN: Operation=Activate
Resources=“GSM Basic Service T11”, “GSM GPRS”, “GSM GPRS APN”,
“GSM Supplementary Services Basic”, “SMS”

OUT: Task 1=NE_I =fnr1
NE_TYPE=FNR
MSISDN1=8728725325
REQ_TYPE=4
REQ_OBJ=1

Task 2=NE ID=Task1.TARGET
NE_TYPE=HLR
MSISDN1=8728725325
IMSI1=2352352523
BASIC_SERVICE=T11
REQ_TYPE=1
REQ_OBJ=1

Task 3=NE_ID=Task1.TARGET
NE_TYPE=HLR
MSISDN1=8728725325
IMSI1=2352352523
SUP_CODES=G01000
REQ_TYPE=1
REQ_OBJ=1

Task 4=NE_ID=Task1.TARGET
NE_TYPE=HLR
MSISDN1=8728725325
IMSI1=2352352523
SUP_CODES=081001
APN=“12.15.163.153”
REQ_TYPE=1
REQ_OBJ=1

Task 5=NE_ID=Task1.TARGET
NE_TYPE=HLR
MSISDN1=8728725325
IMSI1=2352352523
SUP_CODES=04100
REQ_TYPE=1
REQ_OBJ=1

Task 6=NE_ID=sms1
NE_TYPE=SMS
MSISDN1=8728725325
SERVICE=SMS
REQ_TYPE=1
REQ_OBJ=1

After the task decomposition, the system has the information required for executing tasks on the network layer through a network element specific interface modules. Next step is the execution of tasks into network elements.

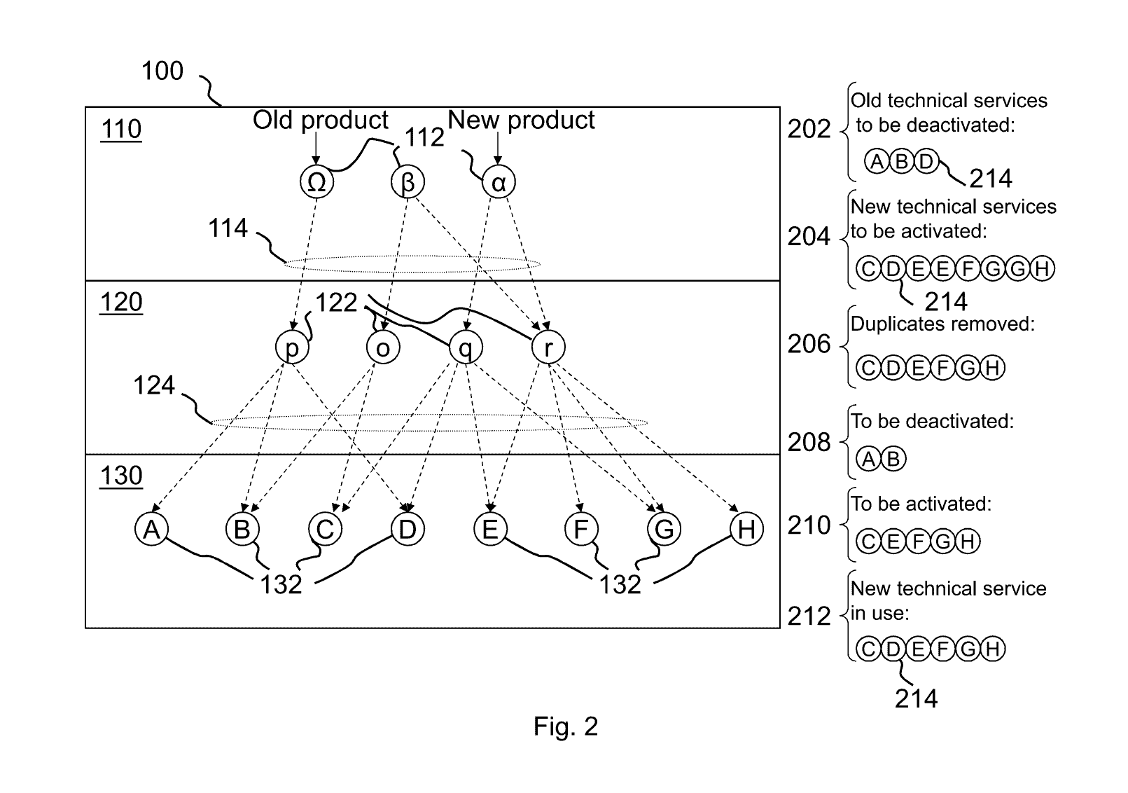

In FIG. 2 there is presented a situation when a subscriber wants to changes from one product to another product.

The modifications on technical service level need both activation and deactivation operations. Also in some cases deletion, parameter changing or other similar operations are needed.

In order to fully take advantage of service catalog, the Customer Care BSS is able to provide old already active (in the example FIG. 2: the product Ω) and new to be activated (in the example FIG. 2: the product α) product information in the modification operation or old already activated product information can be derived from the subscription data in the catalog (if subscription data present in the catalog). From this information the system offers:

1) On the Product to Service level:
extract all the services to be deactivated (in the example: p) 202
extract all the services to be activated (in the example: q and r) 204

2) On the Service to technical service level it identifies if the same services are used for the different products. This leads to make a delta function from the Service level into technical service level and only create references to:
evaluate from upper level the old technical services to be deactivated (in the example: A, B and D) 202.
evaluate from upper level the new technical services to be activated (in the example: C, D, E, E, F, G, G and H 204; Remove duplicates=>C, D, E, F, G and H; 206).
deactivate technical services that are not used by the new product (in the example: A and B) 208.
activate technical services that are not yet active (in the example: C, E, F, G and H) 210.
do nothing for technical services that are the same in the old and new product (in the example: D) 214.

Send referred technical services to network element specific data repository level

3) On the network element specific data repository level:
extract all the technical services to be deactivated into capabilities or functionalities, which can be function specific workflows or network element specific tasks.
extract all the technical resources to be activated into capabilities or functionalities, which can be function specific workflows or network element specific tasks 212.

One advantage of the above-described embodiment compared to known solutions is that instead of first deactivating the whole product and then activating the new product, the system is able to constitute a delta function between the products and only activate and deactivate the changing resources between the products. This minimises the communication into network elements over typically slow network connections and thus speeds up the provisioning overall process.

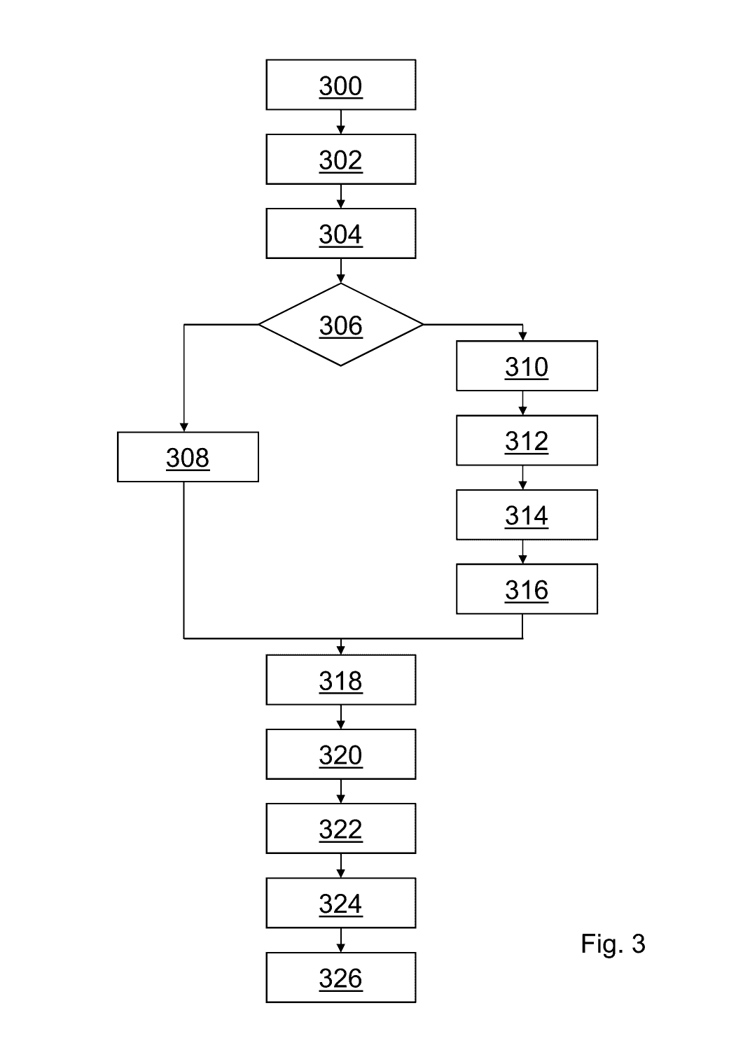

In FIG. 3 according to one embodiment of the invention, the overall process how an activation can be made when a catalog is used together with activation product can be defined as follows:

300 BSS system identifies that a new product has to be assigned with a user (e.g. user orders a new product) or a completely new subscriber, starting to use a product, has to be activated or product has to be removed from the subscriber already having a product.

302 BSS system sends an order to activation or order management system. Order contains information about the subscriber unique identifier and product(s) to be assigned with subscriber as well as the operation (e.g. activate).

304 The order management (or activation) system has a workflow that defines how an order must be processed.

306 The order management system asks data from the catalog either in bits or directly as a decomposition into technical services to be executed, so the operations are either:

308 The order management system provides information about subscriber, product and desired action to catalog. The catalog makes the decomposition into technical services needed to be processed and delivers a list of technical services, operations and their relations (e.g. execution order) to be processed for the order management system.

Or

310 The order management system asks from catalog what products subscriber already has if the subscription data is stored into the catalog. The order management system provides information about subscriber into catalog, which provides information about all the subscriptions, i.e. what products subscriber also has subscription to. If subscription data is not stored into the catalog, the system should preferably provide old, already activated products for the catalog to be used for a delta calculation based on the request from the BSS systems.

312 The order management system asks from catalog decomposition from products into services. The order management system provides information about new products plus operations and current products for the catalog, which provides decomposition to services and operations taking into account what services are needed for the desired product set for a subscriber.

314 The order management system asks from catalog decomposition from services into technical services. The order management system provides information about services plus operations (the data from the previous decomposition) to catalog, which provides decomposition to technical services and operations.

316 The order management system asks the relation of technical services from catalog. The order management system provides technical services and operations to be processed into catalog, which provides information of relations for the technical services (e.g. execution order).

After the decomposition (either of the options), the order management system has a set of technical services, operations for each technical service and relations of them.

318 The order management system pushes request (technical services, operations, relations) to execution (activation to internal layer, order management into activation system).

320 The activation makes conversion of generic technical services into network element specific operations defined in the capability library. The internal operation messages derived from the service activation or deactivation request can be atomic targeted to a single network element or a flow of operations sending multiple messages touching multiple network elements (workflow that defines how operation for a technical service is executed). The conversion from vendor independent service operation into vendor specific task template can be made in the capability library for example through rules, lookup tables or repository that contains transformation data. Or the service can refer to a workflow in the capability library that generates all the messages into multiple network elements and defines the order of messages that all together fulfil the technical service on network layer.

322 The network element specific operations are executed into network through network element interface modules. Each network element vendor and network element type typically implements a vendor and element specific provisioning and activation interface. The network element interface module 470 converts internal message into network element specific commands or provisioning and activation messages. It also converts the response (e.g. provisioning of subscriber executed successfully) from network element into internal message format that is understood by the Activation Component. These responses are then interpreted into status of operation for a technical service (e.g. successful or failed).

324 When all the technical services are executed, the activation system has a status of execution for each technical service and is thus able to either provide this information to order management system, which then updates the product status of subscription (instances of invoked network level technical services for a subscriber) data into catalog, or activation system can interpret status of technical service execution into status of product processed and update the subscription data part into catalog.

326 The response is generated from the order management system into BSS system (e.g. CRM system).

This defines the normal processing workflow. All the abnormal processing situations should preferably be managed also by the processing workflow. For example in case there are problems in the execution of technical services, the activation process should preferably be capable to process the rollback operations. This means either removing a technical service already activated or updating the service parameter values into values before the execution started.

Furthermore, other functions like deactivation, deletion, modification and display are likewise possible to implement with the aid of the invention and the embodiments thereof.

In a preferred embodiment of the invention, the provisioning and activation flow and the catalog are separated. Advantages for this type of approach are that changes or updates can be easily made into the service catalog without affecting the provisioning and activation flow at all. A further advantage is that there is no need to test the provisioning and activation flow, when a service catalog configuration is changed. The generic provisioning workflow will remain the same independently from the provisioned and activated products and services. Also catalog specific user interfaces can be made more easily and also e.g. the OSS/J Inventory API can be implemented as a completely separate from the provisioning logic based on the data from the catalog.

In another embodiment of the invention the different technical services have relations between each others. For example some technical services have to be activated before some other resource one simple example would be mobile subscriber with short message service. The subscriber has to be first activated into HLR before issuing activation commands into SMSC. All the technical services can be thought as a pool of technical services. In case there is a relation with some of the technical services in the pool, this can be defined for example with a priority of technical service or as a direct relationship between technical services.

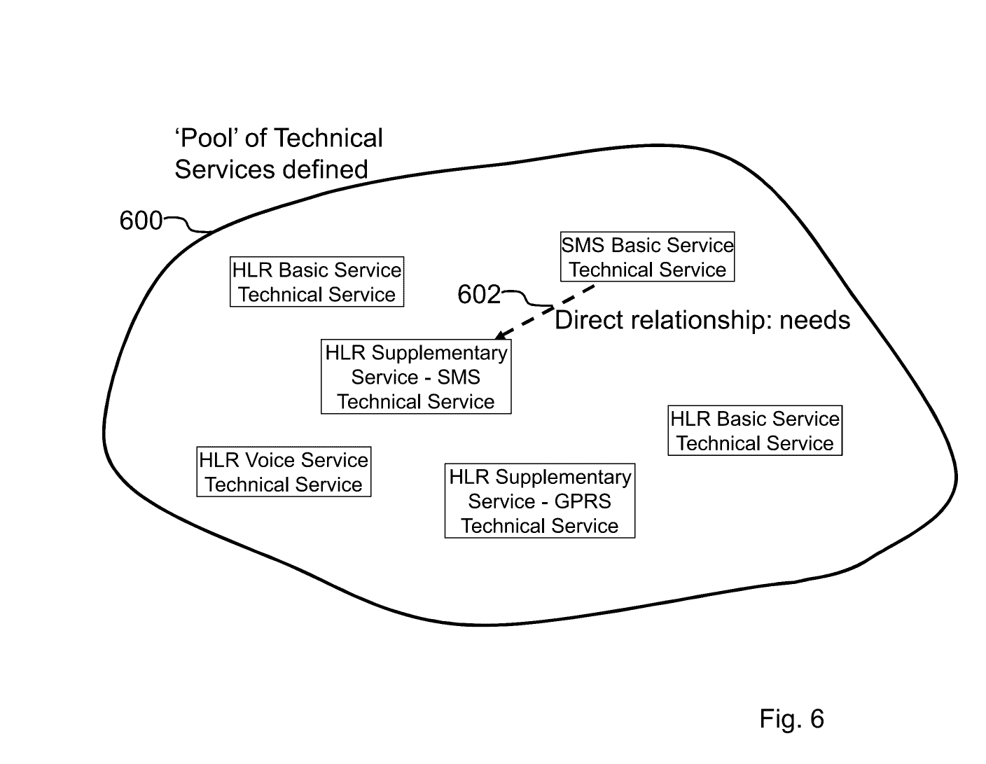

In FIG. 6 the technical service defined into the catalog, referred as a pool 600 of available technical services, have direct relationships. The ‘SMS Basic Service’ needs ‘HLR Supplementary Service—SMS’ in order to work 602. From the activation point of view the needed entity must be activated first before the entity needing it can be activated.

The limitation why execution order cannot be defined on the service layer is that delta of the modification is managed dynamically. There will be indefinite number of delta combinations, so all the relations between technical services should preferably be managed on the technical service layer from the activation point of view. There can still be relations defined, for example, on the service or product layer. But the information can be used to guide the person using the user interface to configure valid configurations.

In FIG. 4 the entities of an embodiment of the invention are presented.

The embodiment comprises of the following components constituting the whole provisioning and activation system:

450 An entity holding a service configuration/specification (catalog). The catalog contains all kind of information regarding products 112, services 122 and technical services 132. There are also determined all the relationships between the products and services 114 and services and technical services 124 in the catalog. The catalog can also contain information regarding to different main functions like e.g. provisioning, activation, mediation, rating and charging purposes. This information can be for instance parameter mappings, relations, prices, tariffs, campaigns, etc. The relationships or dependencies (e.g. needs, not with, etc.) on same logical level are also presented 140.

410 An entity holding a workflow for generic activation process (e.g. request order management component). This entity can be called order management. According to an embodiment of the invention the order management contains all logic 412 that is needed to receive a request 402 from BSS system 400, decompose the request 402 according to relationships between both products and services 114 and services and technical services 124 in catalog 450, to communicate with activation system about technical services to be touched in the activation process.

414 An entity capable to interpret and process the data from the service configuration/specification catalog and provide functionalities used and needed by the generic workflow 412 process for activation. The catalog 450 may contain lot of data, for example regarding products, that is not relevant from the activation process point of view (e.g. price, campaigns, different tariffs, etc.), thus the entity only uses and provides data needed by the activation workflow. In a preferred embodiment of the invention the order management component 410 may contain also a function library 414, in which the relevant information from catalog is replicated. The relevant information is the Product-Service-Technical Service chain with relationships. This gives remarkable advantage for processing the workflow in an increased response times. In case the service configuration in the catalog is updated, the information is delivered by the catalog to the entity and replication information can be reloaded or updated. The Function library 414 contains also the main functions like decomposition rules, relationship management, rollback, delta, etc.

420 An entity making translation from generic service description (the lowest level entity in the catalog, e.g. technical service) into network element specific operation or operations or workflow and execute them (e.g. activation component). This entity contains predefined capability templates 434 and capability logic 432 how the technical services should be executed to each network element 480. The capability templates 434 are the most atomic commands, usually containing only one command or task to be executed. The operations can be invoked into network elements 480. In an embodiment of the invention the capability templates are stored in a network element specific data repository 430. The capability logic 432 comprises of rules or flow including referring to several capability templates 434. The capability logic 432 defines complex operations that can be invoked to a set of network elements 480. Furthermore the capability logic 432 uses network element specific data repository abstractions. The advantage of abstractions are that they easies the configuration substantially by defining the input data needed to invoke operation though a network element interface module 470, while the details are managed by the network element interface module 470.

400 Business Support System (BSS) initiates the whole process. In BSS there are several independent systems like Customer Management, Billing, Planning, etc.

405, 416, 418, 475 Application Program Interfaces (API)

470 Network Element Interface modules (NEI) make conversion from activation system's internal task into network element specific commands or messages that execute the provisioning and activation of service on the network level.

480 Network Elements (NE) implements the service bought by a subscriber technically on the network layer.

The catalog 450 holds the specification of the services. The catalog can have any levels depending on the implementation. Typically two level product or service catalogs have been defined for billing purposes. However there could be also more levels. According to another embodiment of the invention the most critical from the provisioning and activation point of view is the lowermost level. The reasons for this are following:

1. All the entities in the lowermost level should preferably be independently executable in order to enable dynamic decomposition from the upper layers.

2. The only relation between entities in the catalog may be a direct, e.g. needs, not with, which can be dynamically interpreted during the decomposition. During the decomposition from a higher level entity into lowermost entity, it can not be explicitly stated during configuration what will be the set of lowermost entities. Thus rules should preferably be dynamically interpretable (not workflows) during the execution of process.

3. There is very difficult to define workflows on any level on the catalog. Because the lowermost entities referred during execution can be arbitrary set, it's not possible to define a predefined workflow for every arbitrary set of entities in the catalog (including all the levels defined in the catalog).

4. The executable for lowermost entity in the catalog may be atomic (one operation to element) or set of operations to multiple network elements or workflow that is executed and can invoke operations to multiple elements. The main requirement for the lowermost entity is that there is single logical result for the entity (namely failed, successful). The lowermost entity (abstract service) in the catalog is linked into executables presented in the activation module (in the network element specific data repository).

In another embodiment of the invention there can also be used separated order management component and provisioning and activation component. In this situation the order management component uses the upper levels (i.e. subscription, if available, product and service) of service repository. The provisioning and activation component uses the lower levels (i.e. services and technical services) to execute the technical decomposition and execute the operations into the network elements through

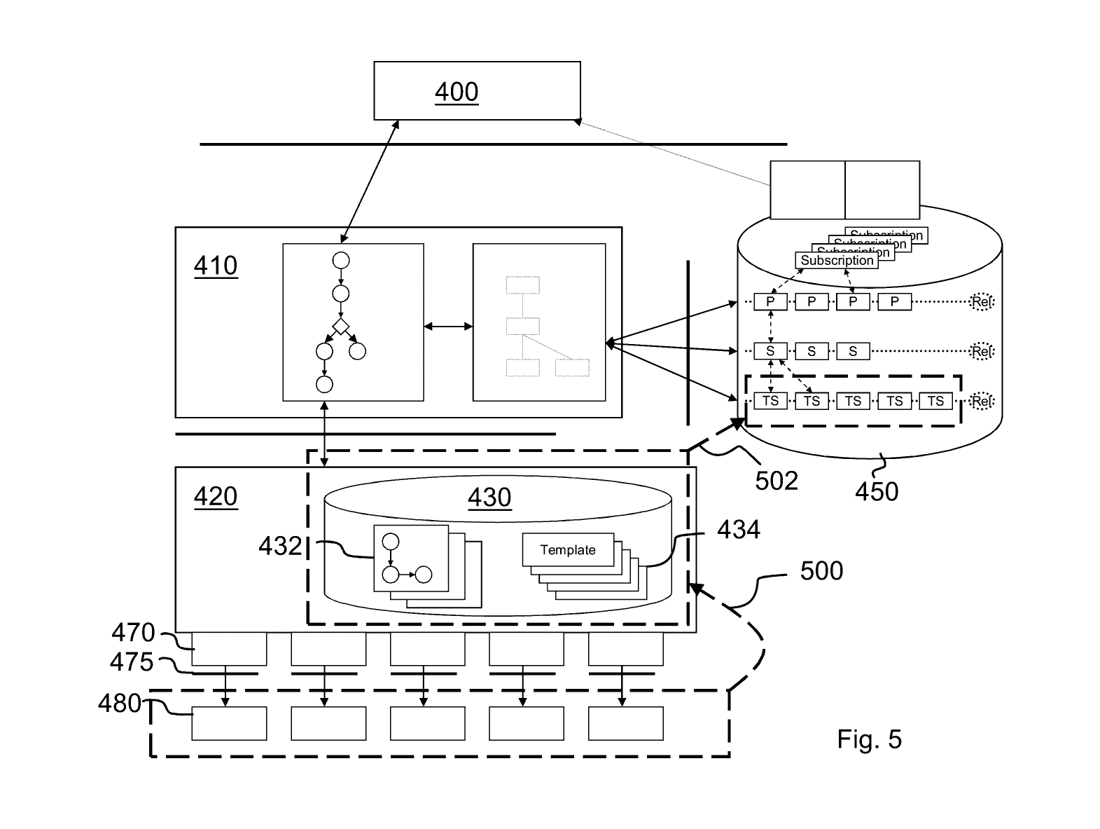

In FIG. 5 a process for defining the technical services into the catalog is highlighted. The technical capabilities of the network are defined by the network elements 480. Thus from the network elements 480, it's possible to derive through the network element interface API 475 the functions that can be executed into the network element 500. The network element specific data repository 430 can be populated with the templates 434 defining the operations that can be supported by the network elements 480. The template defined the data to be send into network element interface module 470 in order to invoke operation in the network element 480. It also defines the dynamic runtime data needed in order to invoke the operation. The information in the template is network element specific, but the data needed to invoke the operation should preferably be defined in generic and network element independent way. The interface into templates defines the generic operations that can be used by the catalog 502. The minimum set of activation and deactivation generic operations define a technical service 132 that can be presented in the catalog 450. In case the logical operation can not be defined by one template, but it's a set of operations into multiple network elements, it can be defined as a workflow, also called capability logic 432, which provides similar API to be used by the technical services in the catalog 502.

In another embodiment of the invention, it is mentioned that the system supports automated rollback. The rollback can be fulfilled with two alternative methods; counter operations or forced subscription setting. The counter operations can be used mainly for activation operations, when some set of technical services is being activated and one of the activations fails, the system can automatically rollback by invoking deactivate operations for all activations already made successfully. The second way can be used also for modifications and deletions, but requires catalog to store information about subscriptions of a subscriber with the history data. Thus system can force the subscriber's subscription into the same status it was before the activation process was invoked.

Refering now to FIG. 4, we further describe some embodiments of the invention. In FIG. 4, there is shown a business support system 400 and a plurality of network elements 480. In between the business support system 400 and the network elements 480, there is a service provisioning and activation system. The service provisioning and activation system comprises a service repository 450 containing service configuration data. The system comprises also an order management component 410, which includes a generic logic 412 for service provisioning and activation operations. In the configuration shown in the Figure, the order management component 410 includes also an operation specific functionalities module 414 comprising operation specific functionalities capable of using data from the service repository 450.

In operation, the order management component 410 receives a provisioning or activation requests from the business support system 400 and processes the received requests according to the generic logic 412. The processing is arranged such that the generic logic 412 calls the operation specific functionalities in the operation specific functionalities module 414 whenever needed. Hence, in this embodiment, the generic logic 412 uses data in the service repository 450 only through the operation specific functionalities in the operation specific functionalities module 414. This hierarchy of logic and functions facilitates both the maintenance of the system and also the reconfiguration of the generic logic whenever needed. By means of this configuration, the system can perform a request-specific series of operations based on the received request and the data from the service repository without the need of programming specific individual workflows for each different service activation, deactivation and modification situation possible in the telecommunications network.

The system of FIG. 4 comprises also a task execution Activation Component 420 and a plurality of network element interface modules 470 for respective network elements 480.

In one possible configuration, the order management component 410 is responsive to a provisioning or activation request to determine a task list comprising a list of modifications in the technical services for the subscription that are necessary on the basis of the provisioning or activation request. The order management component 410 submits this technical service list to the activation component 420, which converts the technical services into capabilities and executes operations into network elements via the relevant network element interface modules 470. In this process, the service set is translated into network-element-specific operations to be executed into the telecommunications network elements 480 in order to fulfil the provisioning or activation request.

The service provisioning and activation system of FIG. 4 includes three different computer systems connected to each other via telecommunications connections. One computer system runs the order management component 410, another computer system runs the service repository 450 and the third computer system runs the task execution component 420 and the network element interface modules 470. The computer systems can be separated or run on the same physical server.

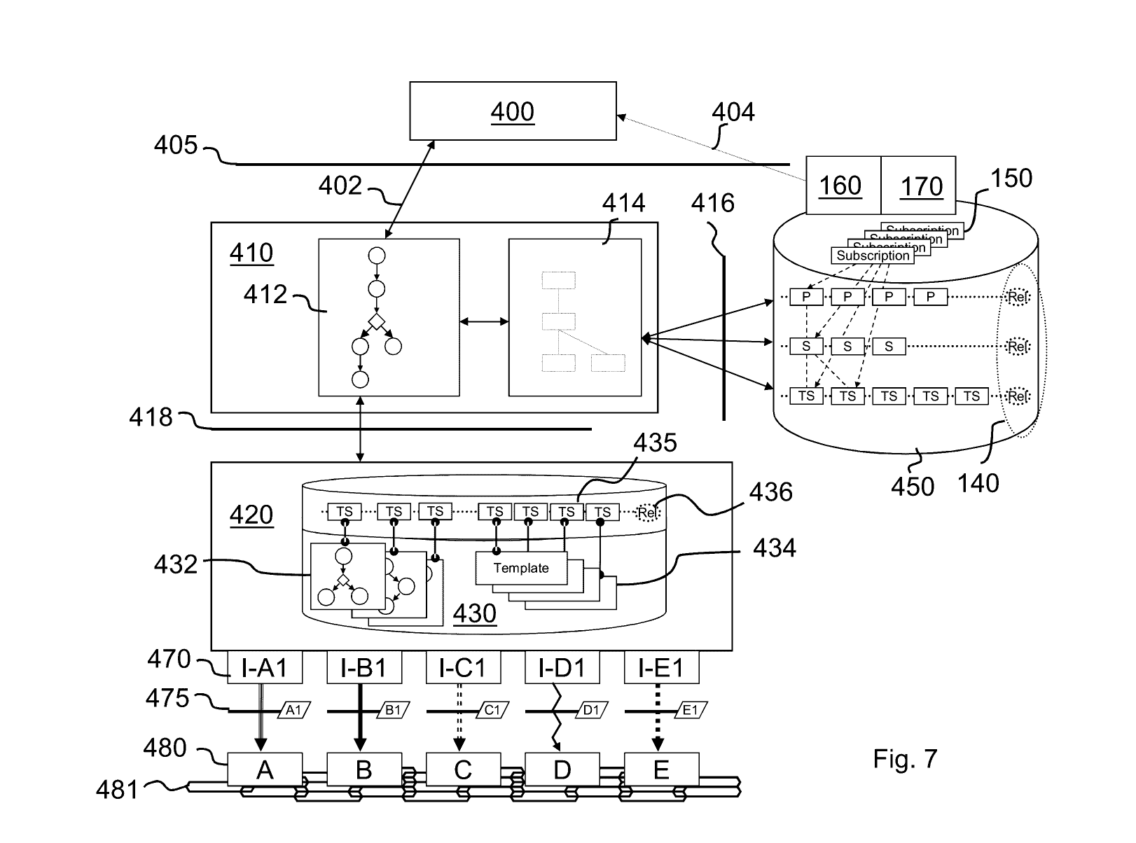

FIG. 7 presents a service provisioning and activation system according to a preferred embodiment of the invention. In FIG. 7, the entities of the embodiment are presented.

The embodiment comprises of the following components constituting the whole provisioning and activation system:

450 An entity holding a service configuration/specification (catalog), presented above in context of FIG. 4.

410 An entity holding a workflow for generic activation process (e.g. request order management component), also presented above in context of FIG. 4.

414 An entity capable to interpret and process the data from the service configuration/specification catalog and provide functionalities used and needed by the generic workflow 412 process for activation, presented above in context of FIG. 4.

420 An entity making translation from generic service description (the lowest level entity in the catalog, e.g. technical service) into network element specific operation or operations or workflow and execute them (e.g. activation component), presented above in context of FIG. 4.

400 Business Support System (BSS) initiates the whole process, as presented above in context of FIG. 4.

405, 416, 418, 475 Application Program Interfaces (API), presented above in context of FIG. 4.

470 Network element interface module, for example I-A1, I-B1, I-C1, I-D1 and I-E1. The network element interface module 470 is used to abstract network element vendor specific provisioning and activation interface (for example MML commands based, HTTP message based, XML file based, Corba IIOP based) into one common message format that can be used by the Activation Component (420). Instead of understanding each network element vendor specific provisioning and activation commands or messages, the Activation Component may use internal message format that is translated into network element interface specific commands or messages by the network element interface module 470. The module converts also network element interface responses, for example ‘IIARC3053 20030442 145116: Subscriber activated’, into internal message format that is understood by the Activation Component.

480 Network Element. The elements to which subscribers have to be provisioned and service activated in order for the subscribers to use network level services (e.g. broadband DSL or mobile voice). The network layer service may have technical relationships and dependencies, for example mobile voice mail service cannot be provided unless mobile voice service is also activated for a subscriber. Or DSL broadband data service cannot be offered without data grade link (virtual channel & path) over backbone ATM network.

481 Network. The network that connects the elements together and provides voice, data and content services to customers, such as broadband DSL service, mobile voice service, mobile data service, multimedia messaging service, television over IP.

430 Capability library contains a library of network level services that Activation Component can manage (provision and activate). The Capability Library defines what is the technical network level service set supported by the Activation Component. The Capability Library defines the network element dependent services, their names and attributes needed in operations for services (e.g. setting the service on, removing activated service) and mapping to the template 434 or workflow 432 that generates one or multiple messages to network element interface to fulfil the provisioning and activation of service on the network level. The capability template 434 can be used when provisioning and activation of a technical service is just one message executed through a network element interface module 470. If the provisioning and activation of a technical service invokes multiple messages to be executed through multiple network element interface modules 470 then Capability logic 432 can be used.

434 Capability template. The Network element interface module 470 provides one single internal message format that can be used to invoke network level service in network elements. The message content can vary between element vendors; element vendor A supports for example larger set of services than element vendor B or B may need a bit different message content that vendor A's network element. The capability template converts a technical service with operation and attributes into an internal message that can be sent to a network element specific interface to be converted into network element specific provisioning and activation commands or messages over network element interface. So, internal messages are linked into human understandable, logical services and a set of messages creates a library of services that can be provisioned and activated through the Activation Component. It can be said that messages are converted into a common message set and each of them are assigned with a logical service name; a service, which the messages invoke (activate/deactivate/modify) on the network level.

432 Capability logic. Since some logical and human understandable network level services (e.g. DSL broadband service) may require multiple messages or commands to be sent into network elements, it must be possible to define a technical workflow that implements the invoking of provisioning and activation messages or commands in the required order to the elements. The workflow can for example first enquire resources to be used on the network level from network inventory, then command workforce management system in order to carry out physical link creation in the network, then activate the service in network element and finally update the network inventory. So the activation of logical technical service (DSL broadband in this example) comprises actually of a number of network interface operations to be executed.

435 Technical service. The capability templates 434 and the capability logics 432 together define a set of technical services that can be activated, deactivated or modified through the Activation Component 420. The technical service is completely network element interface and also network element vendor independent technical service that has a human understandable name and set of attributes that define the needed data in order, for example, to activate the technical service. The order management can refer to single or multiple technical services, with all the attribute information needed by each technical service, to be activated or deactivated.

436 Relations & dependencies between technical services. Since some technical services 435 need some other technical service to be activated before it may be activated, there is a possibility to define dependency that service S1 needs service S2 to be activated before it may be activated. There may be also relationship that some service may not be activated at the same time, for example service S3 may not be activated at the same time when service S2 is activated. The relations and dependencies are defined on the same level as technical services and when defining a new technical service, its possible relations and dependencies can be also set. The dependency information can be used in the activation process to identify in which order technical services need to be activated, when the system gets a command to activate an arbitrary set of technical services.

475 Network Element Interface, for example A1, B1, C1, D1 and E1. Network elements support a provisioning and activation interface in order for external system, such as human administrator manually or provisioning and activation system automatically, to set up a service in the network element that subscriber has a subscription to. Interface varies depending on the network element vendor and network element type. The interface can be, for example, MML (man-machine language) based command line interface, which means that provisioning and activation system must open a terminal connection to the element and invoke MML commands to the element to set up a service for a subscriber. Even if multiple network element types support MML based interface, the syntax is totally different from element to element. This means that to set up a same network level technical service to a subscriber on an element from vendor X, a command ‘set id=+countrycode_subscriberNumber’ has to be used, whereas an element from vendor Y requires a different command, such as ‘create user “subscriberNumber”. Other technologies to invoke provisioning and activation commands into network elements are, for example, Corba IIOP object creation to the element, subscriber creation over remote method invocation method over Java RMI, sending of service activation message over HTTP protocol, etc. There are lot of different technical interface implementations that network element vendors do support.

FIG. 7 highlights provisioning and activation solution that uses process workflow (412) in order/request management component (410) to decompose an activation of service or product from Business Support System (400) into technical services through a service catalog (450) and an activation component (420) to execute technical services into the network (481). The activation component holds the network element interface modules (470) that convert internal message format into network element specific commands or messages. The capability repository (430) holds abstraction from internal messages, which, for example activate, network level capabilities, into human understandable and manageable technical services. The abstraction is done through mapping of internal messages into technical services and their management operations (e.g. set voice service on) using templates (434) or in case of more complex operations on the network level, using workflow, also called capability logic (432), i.e. one technical service and it's operation may refer to multiple operations on the network layer meaning multiple messages over network element interface modules.

A process for defining the technical services into the catalog through activation component is highlighted. The network elements (480) define the technical capabilities of the network to support telecom services for subscribers. The network element interface modules (470) reflect (800) the services that can be provisioned and activated through them into the network elements (480). The network element interface module can manage only the services that the network elements are supporting. The network element interface modules have an internal message format that can be used to invoke interface module to execute an activation command or to send activation message into a network element. To define a set of services that can be managed through the activation component, a translation of network element interface module messages into services and their supported operations is done in the capability library (430). The capability library supports only services that can be managed through the network element interface modules (802). The service messages in the capability library may have network element specific message content, i.e. the message to activate the same service requires a different type of parameter set to vendor A compared to vendor B. The templates (434) are used to convert vendor specific messages into messages with a common parameter set. If the service operation, for example activation, means multiple messages over the network element interface modules, a workflow, also called capability logic (432) can be used to model the activation procedure. Both the templates (434) and workflows, also called capability logic (432) can be then converted (804) into logical technical services (e.g. mobile voice, DSL, PSTN voice) and their operations (e.g. set, remove, change Mobile Subscriber ISDN number). When the technical service set is defined, the service management data is on such a level that it can be exported (806) into external systems, such as service catalogues (450), that need to have understanding of technical services the telecom network is supporting.

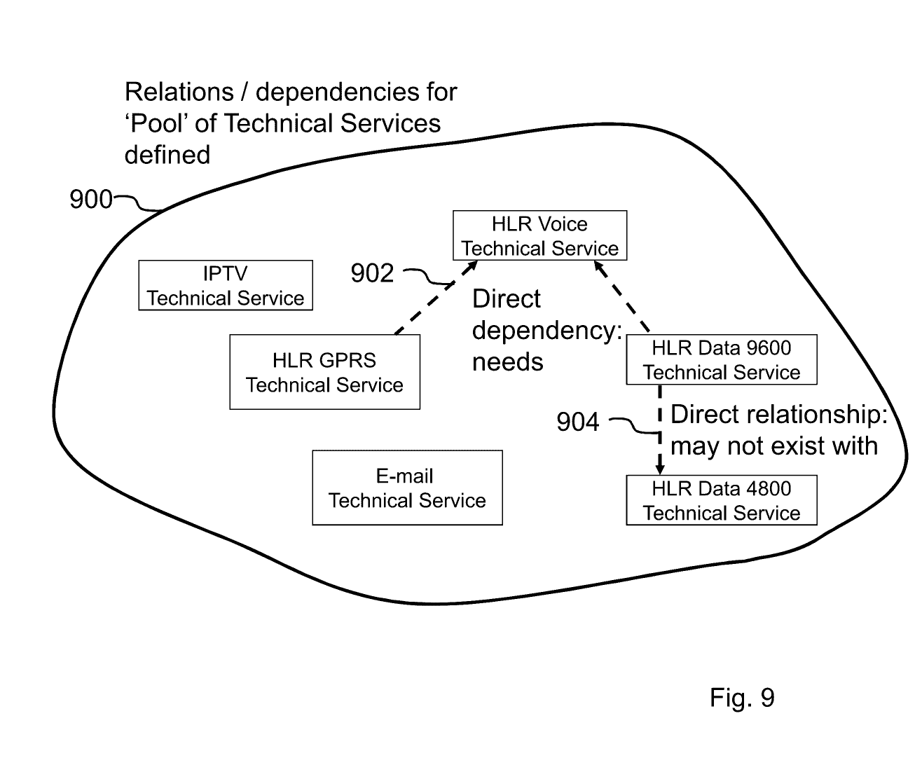

In FIG. 9, the technical services refer to the technical service set in the capability library that models the technical services supported by the telecom network. Since technical services may have dependencies and relationships on the network level, the relationships and dependencies can be modelled also on the capability library. This is needed in order for the system to be able to guide a person defining a technical service bundles to define only such service bundles that are valid from the network point of view. During the runtime, the relationship and dependency data is needed to check that referred technical service set to be activated is valid and also to identify the correct processing order of technical services. The FIG. 9 highlights both the dependency and relationship: Firstly, the HLR voice technical service needs to be activated before a HLR GPRS technical service can be activated, thus the HLR GPRS needs HLR voice (902). And secondly, the HLR Data 9600 technical service has a relationship “may not exist with (904) HLR Data 4800”, meaning that both technical services may not be active at the same time from the network point of view.

The above description is only to exemplify the invention and is not intended to limit the scope of protection offered by the claims. The claims are also intended to cover the equivalents thereof and not to be construed literally.

1. A service provisioning and activation system in a first computer system associated with a telecommunications network, comprising:
a service repository in the first computer system for storing service configuration data, which comprises data on telecommunications products or services provided by the telecommunications network,
an operation specific functionalities module comprising operation specific functionalities capable of using data from the service repository of the first computer system, and
an order management component comprising a generic logic for service provisioning and activation operations, the order management component being operative to receive a provisioning or activation request from a business support system and process the received request according to the generic logic, the generic logic being further operative to call the operation specific functionalities in the operation specific functionalities module in order to perform a request-specific series of operations based on the received request and the data from the service repository.
wherein the order management component and the service repository are adapted to decompose the provisioning or activation request from the business support system and to convert the request into corresponding changes in technical services, and
the service provisioning and activation system further comprises:
an activation component adapted to execute the changes in the technical services into the telecommunications network and into a plurality of network elements of the telecommunications network,
wherein the activation component includes a capability repository adapted to convert the changes in the technical services into at least one message in an internal message format, and in an opposite direction, and to provide an abstraction from the messages in the internal message format into a technical services format, which is human understandable and manageable, and
the activation component includes network element interface modules adapted to convert the messages in the internal message format into telecommunications network element specific commands or messages.

2. The system of claim 1, wherein the service configuration data in the service repository comprises, for each of the telecommunications products or services, data on technical services or capabilities offered by the telecommunications network that are necessary in order to provide said telecommunications product or service.

3. The system of claim 1, wherein the service configuration data in the service repository includes data on subscriptions that are in activated state in the telecommunications network.

4. The system of claim 3, wherein the service configuration data in the service repository relates each of the subscriptions to the respective telecommunications products or services that are in activated state for said subscription.

5. The system according to any of claim 2, wherein the service configuration data in the service repository is arranged according to the Shared Information Data model (SID).

6. The system according to any of claim 2, wherein the provisioning or activation request from the business support system indicates a subscription and a desired operation for the subscription on a product and/or service level.

7. The system of claim 6, wherein the service provisioning and activation system is responsive to the provisioning or activation request to determine a task list comprising a list of modifications in the technical services or capabilities for the subscription that are necessary on the basis of the provisioning or activation request.

8. The system of claim 7, comprising a task execution component and a plurality of network element interface modules for respective network elements, wherein the task execution component is operative to execute the tasks in the task list via the relevant network element interface modules, whereby the task list is translated into network-element-specific operations to be performed in the telecommunications network elements in order to implement the provisioning or activation request.

9. The system according to claim 1, comprising decomposition functionalities operative to decompose a service description on a product level or a service level into a corresponding service description on a technical services or capabilities level.

10. The system according to claim 1, wherein the operation specific functionalities include a relationship functionality capable of arranging the technical services or capabilities in a correct order of activation, deactivation or modification based on the technical relationships between said technical services or capabilities.

11. The system according to claim 1, wherein the operation specific functionalities include a rollback functionality capable of restoring the status of the subscription valid at the moment of receipt of the provisioning or activation request.

12. The system according to claim 1, comprising an update functionality operable to update the service configuration data in the service repository in response to a successfully performed provisioning or activation operation.

13. The system according to claim 1, comprising a delta functionality operable to determine the minimum changes in the technical services or capabilities that are necessary in order to implement the provisioning or activation request.

14. The system of claim 13, wherein the delta functionality is operable to
determine the technical services or capabilities in an active state in the telecommunications network based on the service configuration data in the service repository,
determine the technical services or capabilities that are needed for the products and/or services that should be active after the change defined in the provisioning or activation request, wherein this determination is based on the provisioning or activation request and the service configuration data in the service repository, and
determine the technical services or capabilities delta, i.e. the changes needed in order to change the group of presently active technical services or capabilities into the group of technical services or capabilities that should be active after the change defined in the provisioning or activation request.

15. The system according to claim 1, wherein the network elements have different command languages and/or command syntaxes, and the service provisioning and activation system is adapted to provide interfaces between the request-specific series of operations provided by the order management component and the commands understandable by the particular ones of the network elements.

16. The system according to claim 1, comprising
the network element interface modules in communication with the respective network elements of the telecommunications network, and
a task execution component in communication with the order management component and the plurality of network element interface modules.

17. The system of claim 16, wherein
the order management component is operative to produce a set of necessary generic operations on the basis of the provisioning or activation request and the service configuration data, and to submit the produced set of generic operations to the task execution component,
the task execution component is responsive to the submitted set of generic operations to convert the generic operations into network-element-specific operations and to distribute the network-element-specific operations to the respective ones of the plurality of network element interface modules, and
the network element interface modules are operative to convert the network-element-operations into network-element-specific commands and to submit said commands to the respective telecommunications network elements.

18. The system of claim 16, wherein
the plurality of network element interface modules provide a network element interface, which allows managing the plurality of network elements using a common set of commands, and
the task execution component provides a technical-service-level interface for the order management component, which technical-service-level interface is capable of transmitting commands between the order management component and the task execution component at the technical-service-level of abstraction, and the task execution component is connected to the network element interface and adapted to provide translations between the technical-service-level interface and the network element interface.

19. The system according to claim 16, wherein the task execution component is operative to derive from the network elements information on the capabilities offered by said elements, and based on the derived information, to provide the service repository with up-to-date information on the technical services or capabilities available in the telecommunications network.

20. The system according to claim 16, wherein the task execution component includes capability templates to be used in converting a request that defines a technical service and associated parameters into a message containing corresponding commands in a form understandable by the network element interface modules.

21. The system according to claim 16, wherein the task execution component includes capability logics to be used in converting a request that defines a specific one of the technical service and associated parameters into message containing corresponding commands in a form understandable by the network element interface modules.

22. The system of claim 21, wherein each of the capability logics contains a technical workflow that defines the messages and commands to be sent to the network element interface modules and the order of sending said messages and commands.

23. The system according to claim 1, wherein the operation specific functionalities module is comprised by the order management component.

24. The system of claim 23, wherein the order management component comprises a replicate database replicating part of the service configuration data in the service repository.

25. The system of claim 23, wherein the first computer system is operable to run the service repository, and the service provisioning and activation system further comprises
a second computer system operable to run the order management component.

26. (canceled)

27. The system of claim 1, wherein the abstraction is done through mapping of internal messages into technical services and their management operations using templates, or in case of more complex operations wherein one technical service and operation thereof refer to multiple operations on the network layer, using workflows.

28. The system of claim 27, wherein the system is adapted to use capability templates, capability logic and/or the capability repository to convert messages in the internal message format into messages in a network-element-specific format.

29. The system of claim 27, comprising a capability repository containing all the necessary capability logics and capability templates.

30. The system according to any of claim 27, adapted to use the capability template to convert the specific technical service with operation and attributes into an internal message that can be sent to a network element specific interface to be converted into network element specific provisioning and activation commands or messages over network element interface.

31. The system according to claim 27, wherein the information in the capability template is network element specific.

32. The system according to claim 27, wherein the capability logic comprises at least two capability templates.

33. The system according claim 1, wherein the capability repository comprises dependencies and relationships of the technical services.

34. The system according to claim 1, wherein the system is adapted to enquire resources to be used on the network level from a network inventory component, then command a workforce management system in order to carry out physical link creation in the network, then activate the service in the network element and finally update the network inventory.

35. The system according to claim 1, comprising a capability library defining the network element dependent services, their names and attributes needed in operations for technical services, and the mapping to the capability template or capability logic that generates one or multiple messages to network element interface to fulfil the provisioning and activation of service on the network level.

36. The system of claim 35 wherein the conversion from internal message format into vendor-specific format is done in the capability library.

37. The system of claim 35 wherein network element interface modules convert the internal messages into network-element-specific commands or provisioning and activation messages.

38. The system according to claim 1, wherein the system is adapted to provide a rollback function for cancelling the changes made.

39. The system according to claim 1, wherein the network element interface modules are adapted to abstract network-element-specific provisioning and activation interfaces into one common message format that can be used by the activation component.

40. The system according to claim 1, wherein the network element interface modules are adapted to control the respective network elements and the communication between the network element interface modules and the respective network elements is arranged via respective network element interfaces.

41. The system of claim 40, wherein the communication between the network element interface modules and the respective network elements is implemented by using MML commands, HTTP messages, XML files or Corba IIOP messages.

42. The system according to claim 1, wherein the network elements provide a group of services that can be provisioned and activated into the network elements, and the network element interface modules reflect the said group of services.

43. The system of claim 42, wherein the capability library supports the group of services reflected by the network element interface modules.

44. The system of claim 43, comprising a technical service set comprising a conversion of the group of supported services into logical technical services and their operations.

45. The system of claim 44, comprising an export functionality for exporting the technical service set into an external system or to the service repository.

46. A method of operating a service provisioning and activation system in a first computer system of a telecommunications network, the provisioning and activation system comprising:
a service repository in the first computer system, said service repository containing service configuration data, an operation specific functionalities module with operation specific functionalities capable of using data in the service repository of the first computer system, and an order management component containing a generic logic for service provisioning and activation operations, the method comprising:
receiving and interpreting a provisioning or activation request from a business support system,
responsive to the request, using the first computer system for processing through the generic logic in the order management component based on the information in the request, said processing comprising calling operation specific functionalities in the operation specific functionalities module and making use of the service configuration data in the service repository via said called operation specific functionalities,
decomposing the provisioning or activation request from the business support system and converting the request into corresponding changes in technical services by means of the order management component and the service respository,
executing the changes in the technical services into the network elements and network by means of an activation component,
converting the changes in the technical services into at least one message in an internal message format by means of a capability repository,
converting the messages in the internal message format into network element specific commands or messages by means of network element interface modules, and
providing an abstraction from the messages in the internal message format into technical services format, which is human understandable and manageable.

47. The method of claim 46, comprising automatically determining the changes necessary in the technical services or capabilities of telecommunications network for implementing the received provisioning or activation request.

48. The method of claim 46, wherein the received provisioning or activation request concerns an activation of at least one new product or service for a subscription and the method further comprises:
determining the technical services or capabilities for the subscription that are in an activated state in the telecommunications network,
determining the technical services or capabilities necessary for implementing the received request, and
activating the technical services or capabilities for the subscription that are necessary for implementing the received request and are not in an activated state in the telecommunications network.

49. The method of claim 48, wherein the determining of the activated technical services or capabilities comprises
retrieving from the service repository a listing of the products or services in activated state for the subscription, and
decomposing the listing into a list of the technical services or capabilities necessary to provide the products or services in activated state.

50. The method of claim 48, further comprising:
forming a first group of technical services or capabilities consisting of the technical services or capabilities for the subscription that are already in an activated state in the telecommunications network,
forming a second group of technical services or capabilities consisting of the technical services or capabilities necessary for implementing the received request,
forming a third group of technical services or capabilities consisting of all the technical services or capabilities appearing in the second group but not in the first group, and
performing the activation exclusively with regard to the technical services or capabilities appearing in the third group.

51. The method according to claim 48, comprising arranging the technical services or capabilities to be activated into an activation order taking into account the technical relationships between the technical services or capabilities, and activating the technical services or capabilities in the arranged activation order.

52. The method of claim 46, wherein the received provisioning or activation request concerns a deactivation of at least one of the existing products or services from a subscription, and the method comprises
determining a deactivation group, i.e. the group of technical services or capabilities for the subscription that are necessary for the at least one product or service to be deactivated,
determining a remaining services group, i.e. the group of technical services or capabilities for the subscription that are necessary for the existing products or services not to be deactivated, and
deactivating only the technical services or capabilities for the subscription that are members of the deactivation group and not members of the remaining services group.

53. The method of claim 52, wherein the determining of the deactivation group comprises decomposing the at least one service or product to be deactivated into a list of the technical services or capabilities necessary to provide said at least one service or product.

54. The method of claim 52, wherein the determining of the remaining services group comprises:
retrieving from the service repository a listing of the products or services in activated state for the subscription,
removing from the listing the at least one service or product to be deactivated, and
decomposing the listing into a list of the technical services or capabilities necessary to provide the products or services in activated state.

55. The method of claim 46, wherein the received provisioning or activation request concerns a change in the set of products or services provided for a subscription, and the method comprises
determining the technical services or capabilities in an activated state for the subscription in the telecommunications network,
determining the technical services or capabilities that are needed for the products and/or services that should be in activated state after the change defined in the provisioning or activation request, and
determining the technical services or capabilities delta, i.e. the changes needed in order to change the group of presently activated technical services or capabilities into the group of technical services or capabilities that should be in activated state after the change defined in the provisioning or activation request.

56. The method of claim 55, wherein
the step of determining the technical services or capabilities in activated state in the telecommunications network comprises retrieving from the service repository a listing of the products or services in activated state for the subscription, and decomposing the listing into a list of technical services or capabilities necessary to provide the products or services in activated state,
the step of determining the technical services or capabilities that should be in activated state after the change comprises retrieving from the service repository a listing of the products and/or services that should be in activated state, and decomposing the listing into a list of technical services or capabilities necessary to provide said products and/or services, and
the step of determining the technical services or capabilities delta comprises comparing the lists and on the basis of the comparison, providing a list of technical services or capabilities that must be activated and a list of technical services or capabilities that should be deactivated.

57. The method of claim 55, comprising arranging the technical services or capabilities to be activated and deactivated into a processing order taking into account the technical relationships between the technical services or capabilities, and activating and deactivating the technical services or capabilities in the arranged processing order.

58. The method according to claim 47, comprising decomposing the changes necessary in the technical services or capabilities into the respective network element tasks.

59. The method of claim 58, comprising executing the network element tasks into the network elements through network element interface modules.

60. The method according to claim 47, comprising
responsive to the changes necessary in the technical services, forming command messages in a generic network element command format,
directing the formed command messages to particular network elements,
translating the command messages into network-element-specific commands, and
transmitting the network-element-specific commands to the respective network elements.

61. The method of claim 60, comprising executing the network-element-specific commands at the respective network elements.

62. The method of claim 61, comprising confirming the successful execution of the network-element-specific commands at the respective network elements.

63. The method according to claim 60, wherein the step of forming command messages in a generic network element command format comprises using a capability template to convert a technical service and the associated parameters into a command message.

64. The method of according to claim 60, wherein the step of forming command messages in a generic network element command format comprises using a capability logic to convert technical services and the associated parameters into a set of command messages having a defined order for transmission to the respective network elements.

65. The method according to claim 46, comprising:
monitoring network elements of the telecommunications network,
on the bases of said monitoring, constructing data on the technical services or capabilities available in the telecommunications network, and
updating the data in the service repository on the bases of said constructed data on the technical services or capabilities available in the telecommunications network.

66. The method according to claim 45, comprising replicating at least part of the service configuration data from the service repository to the order management component.

67. (canceled)

68. (canceled)

69. (canceled)

70. The method of claim 46, comprising providing the abstraction by mapping the internal messages into the technical services and their management operations using templates, or in case of more complex operations wherein one technical service and it's operation refer to multiple operations on the network layer, using workflows.

71. The method according to any of claims 46, comprising using capability templates, capability logic and/or capability repository to convert messages in the internal message format into messages in a network-element-specific format.

72. The method of claim 71, wherein the information in the capability template is network element specific.

73. The method according to 46, comprising
enquiring resources to be used on the network level from a network inventory component,
commanding a workforce management system to carry out physical link creation in the telecommunication network,
activating the service in the network element, and
updating the network inventory.

74. The method according to claim 46, comprising abstracting network-element-specific provisioning and activation interfaces into one common message format that can be used by the activation component.

75. The method according to claim 46, comprising controlling the network elements via network element interface modules and the respective network element interfaces.

76. The method of claim 75, wherein the network element interface modules and the respective network elements communicate using MML commands, HTTP messages, XML files or Corba IIOP messages.

77. The method according to claim 46, wherein the network elements provide a group of services that can be provisioned and activated into the network elements, and the network element interface modules reflect the said group of services.

78. The method of claim 77, wherein the capability library supports the group of services reflected by the network element interface modules.

79. The method of claim 78, comprising providing a technical service set comprising a conversion of the group of supported services into logical technical services and their operations.

80. A non-transitory computer readable medium, having stored thereon a computer program product comprising computer program code operable to instruct a computer system to perform A method of operating a service provisioning and activation system in a first computer system of a telecommunications network, the provisioning and activation system comprising:
a service repository in the first computer system, said service repository containing service configuration data, an operation specific functionalities module with operation specific functionalities capable of using data in the service repository of the first computer system, and an order management component containing a generic logic for service provisioning and activation operations, the method comprising:
receiving and interpreting a provisioning or activation request from a business support system,
responsive to the request, using the first computer system for processing through the generic logic in the order management component based on the information in the request, said processing comprising calling operation specific functionalities in the operation specific functionalities module and making use of the service configuration data in the service repository via said called operation specific functionalities,
decomposing the provisioning or activation request from the business support system and converting the request into corresponding changes in technical services by means of the order management component and the service respository,
executing the changes in the technical services into the network elements and network by means of an activation component,
converting the changes in the technical services into at least one message in an internal message format by means of a capability repository,
converting the messages in the internal message format into network element specific commands or messages by means of network element interface modules, and
providing an abstraction from the messages in the internal message format into technical services format, which is human understandable and manageable.

81. A method of using the service provisioning and activation system according to claim 1, wherein the
providing the business support system with a business-level view of the services in activated state for a subscription of interest in the telecommunications network.

82. A method of using the service provisioning and activation system according to claim 1, wherein the business support system operates on the first computer system, the method comprising:
implementing a business-level request using the business support system to request at least one change in the services provided for a subscription of interest in the telecommunications network.
